(19) United States
(12) Patent Application Publication
(10) Pub. No.: US 2019/0187457 A1
(43) Pub. Date: Jun. 20, 2019

(54) HELIOSTAT SYSTEM

(71) Applicants: Wi-Cher Lim, Acton, MA (US); John Koger, Dedham, MA (US)

(72) Inventors: Wi-Cher Lim, Acton, MA (US); John Koger, Dedham, MA (US)

(21) Appl. No.: 16/223,648

(22) Filed: Dec. 18, 2018

Related U.S. Application Data
(60) Provisional application No. 62/607,536, filed on Dec. 19, 2017.

(51) Int. Cl. G02B 26/08; G02B 7/182; G05B 15/02

(52) U.S. Cl. CPC G02B 26/0816; G05B 15/02; G02B 7/1821

(57) ABSTRACT

A heliostat includes a frame, a mirror coupled to the frame, a first actuator configured to rotate the mirror about a horizontal axis relative to the frame, a second actuator configured to rotate the mirror about a vertical axis relative to the frame, an angle indicator including data indicating an angle of the mirror relative to the frame, a time keeper, and a computing system. The computing system includes a processor, a memory, and a wireless communications interface. The computing system calculates a sun position using the time keeper, determines an approximate mirror angle to reflect sunlight towards a target by utilizing the sun position, a location of the frame, and an approximate alignment of the frame relative the target, and automatically adjusts the mirror to the approximate mirror angle based on the angle indicator by activating the first and second actuators.

### CROSS-REFERENCE TO RELATED APPLICATION

This application claims the benefit of priority of U.S. provisional application No. 62/607,536, filed Dec. 19, 2017, the contents of which are herein incorporated by reference.

### BACKGROUND OF THE INVENTION

The present invention relates to a heliostat and, more particularly, to a heliostat for home use.

A heliostat is a device that includes a mirror, usually a plane mirror, which turns so as to keep reflecting sunlight toward a predetermined target, compensating for the sun's apparent motions in the sky.

Some individuals prefer to have sunlight directed into their house to improve living conditions. Heliostats are predominantly used for industrial purposes. Such heliostats are large, expensive, and require multi-disciplinary expertise to install and operate. Therefore, industrial heliostats are not very practical for a normal consumer who prefers sunlight directed through an average sized window. Certain heliostats that are for normal consumer purposes use consumer-grade technologies, but they are too unreliable to be useful.

As can be seen, there is a need for a heliostat that can be purchased at a reasonable cost and operated with reasonable ease.

### SUMMARY OF THE INVENTION

In one aspect of the present invention, a heliostat system comprises: a frame; a mirror coupled to the frame; a first actuator configured to rotate the mirror about a horizontal axis relative to the frame; a second actuator configured to rotate the mirror about a vertical axis relative to the frame; an angle indicator comprising data indicating an angle of the mirror relative to the frame; a time keeper; and a computing system comprising a processor, a memory, and a wireless communications interface, wherein the processor calculates a sun position using the time keeper, determines an approximate mirror angle to reflect sunlight towards a target by utilizing the sun position, a location of the frame, and an approximate alignment of the frame relative the target, automatically adjusts the mirror to the approximate mirror angle based on the angle indicator by activating the first and second actuators, manually adjusts the mirror from the approximate mirror angle to an angle that reflects the sunlight to the target by wirelessly receiving a manual input from a remote device via the wireless communications interface if the mirror is not reflecting the sunlight to the target at the approximate mirror angle, and refines subsequent approximate mirror angles based on the manual input.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is a perspective view of an embodiment of the present invention;

FIG. 3 is a section view of the present invention, taken along line 3-3 in FIG. 2;

FIG. 4 is a section view of the present invention, taken along 4-4 in FIG. 2; and

FIG. 5 is detailed section view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a low cost and easy to setup consumer purpose heliostat. A heliostat tracks the sun to reflect sunlight into the house through an opening, for example, a window. The present invention includes a heliostat that utilizes sophisticated algorithms to eliminate the need for expensive high precision mechanical parts used in existing heliostats. The present invention is easily setup by leveraging a smartphone graphics user interface (GUI), wireless connections, computational power, built-in global positioning system (GPS), accelerometer, gyroscope, compass, and camera to calculate and program the heliostat's location and its alignment. The heliostat of the present invention operates autonomously without need for external power by a combination of mechanical, electrical, and on-board firmware inter-works such that the power requirement can be fully met by small, inconspicuous, low power solar panels.

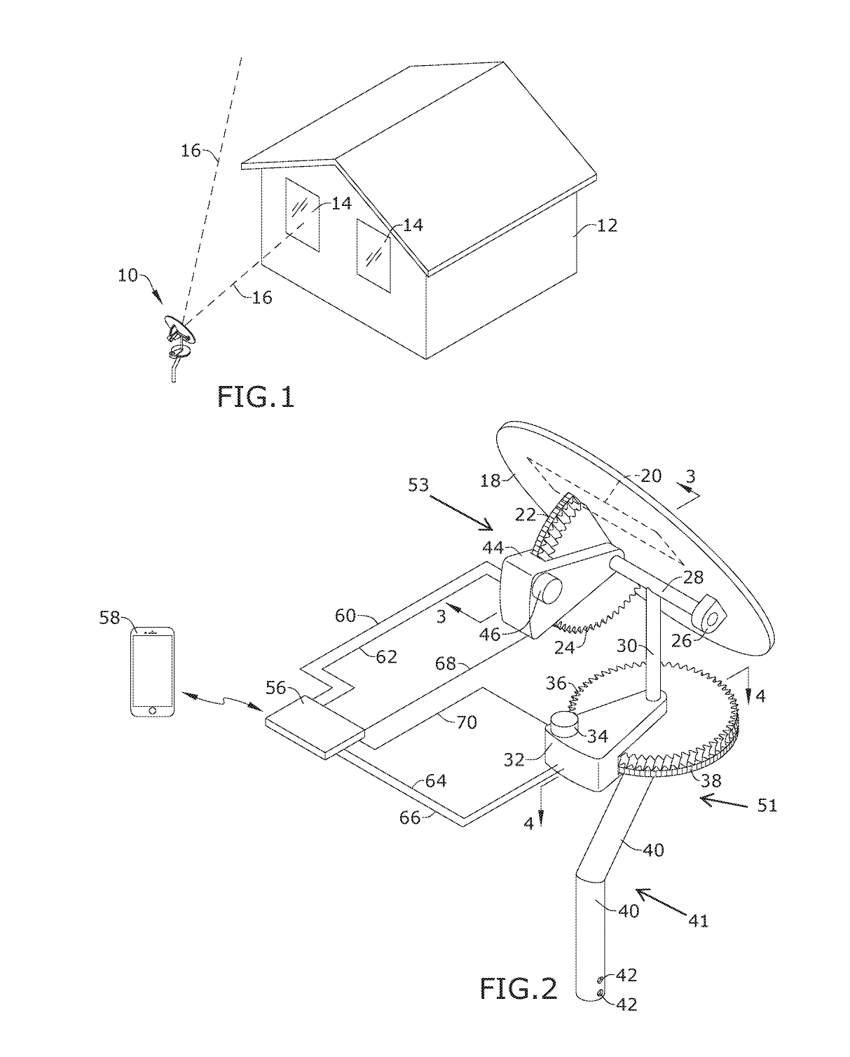

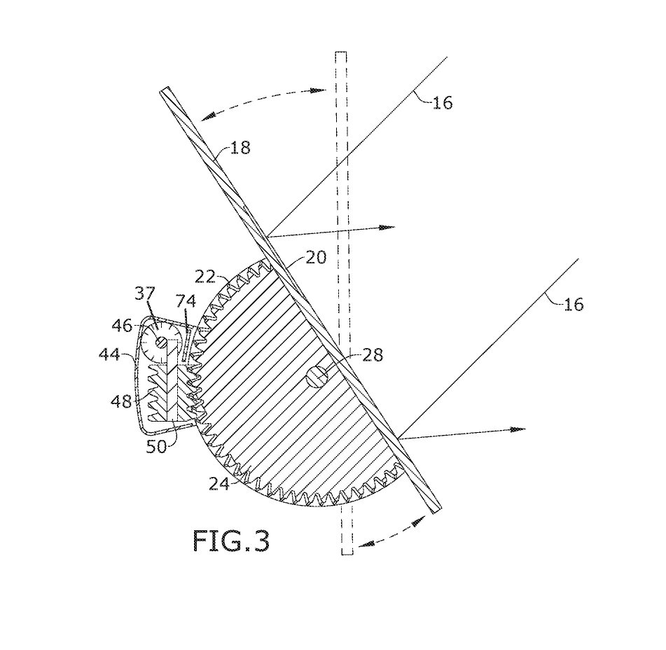

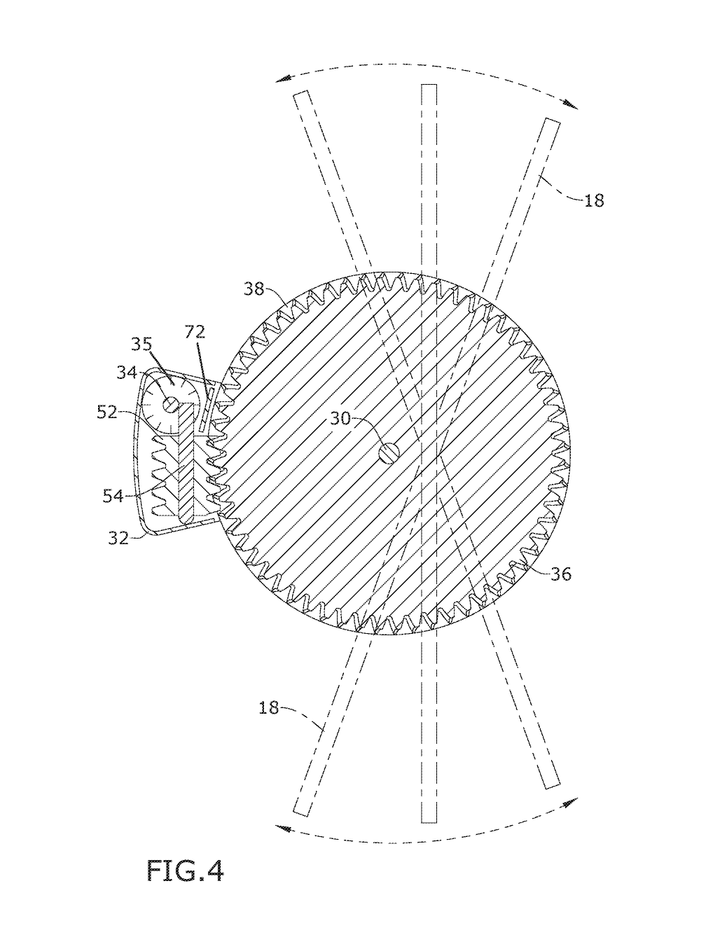

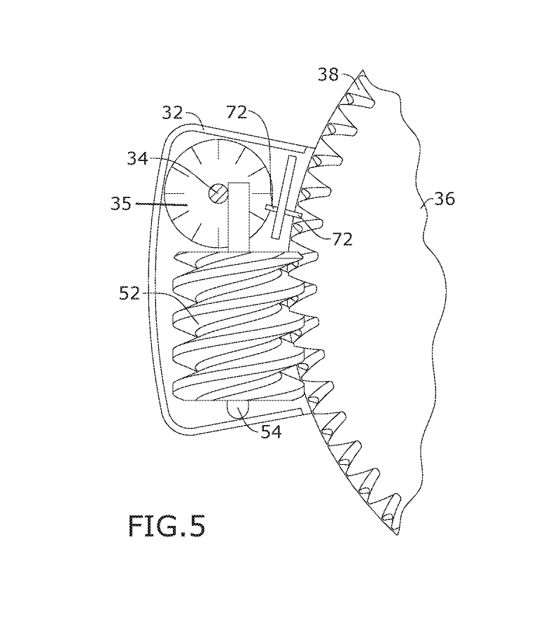

Referring to FIGS. 1 through 5, the present invention includes a heliostat 10. The heliostat 10 includes a frame 41, a mirror 18 coupled to the frame 41, a first actuator 51 configured to rotate the mirror 18 about a horizontal axis relative to the frame 41, a second actuator 53 configured to rotate the mirror 18 about a vertical axis relative to the frame 41, an angle indicator 22, 38 including data indicating an angle of the mirror 18 relative to the frame 41, a time keeper, and a computing system 56. The computing system 56 includes a processor, a memory, and a wireless communications interface.

The computing system 56 of the present invention calculates a sun position using the time keeper and determines an approximate mirror angle to reflect sunlight 16 towards a target 12, 14 by utilizing the sun position, a location of the frame, and an approximate alignment of the frame relative the target. The computing system 56 then automatically adjusts the mirror 18 to the approximate mirror angle based on the angle indicator 22, 38 by activating the first and second actuators 51, 53. The computing system 56 may then manually adjusts the mirror 18 from the approximate mirror angle to an angle that reflects the sunlight 16 to the target 12, 14 by wirelessly receiving a manual input from a remote device 58 via the wireless communications interface if the mirror 18 is not reflecting the sunlight 16 to the target 12, 14 at the approximate mirror angle. Subsequent approximate mirror angles are refined based on the manual input.

The present invention may include a system that includes the heliostat 10 and the remote device 58. The remote device 58 may be a smart device, such as a smart phone or tablet. Alternatively, the remote device 58 may be a desktop or laptop. The remote device 58 includes a user Interface to control the heliostat 10, a processor, a memory, and a wireless communication interface. The remote device 58 may further include positional sensing and imaging system. The positional sensing and imaging system may include, a global positioning system (GPS), an accelerometer, a gyroscope, a compass, and a camera. Data transfer between the remote device 58 and the computing system 56 of the heliostat 10 is done over a wireless communications channel, such as BLUETOOTH ®, a wireless network, or the Internet.

The frame 41 of the present invention may include a chassis 40 with mounting holes 42. The frame 41 may be mounted to the surface of the earth using the mounting holes 42. The frame 41 is mounted to face the target 12, 14. The target 12, 14 of the present invention may be a window 12 of a house 14.

The location of the frame 41 is determined by placing the remote device 58 on the mirror 18, in which the global positioning system records the location. The approximate alignment of the frame 41 relative to the target 12, 14 is determined by placing the remote device 58 on the mirror 18, in which the accelerometer measures a 2-axis inclination of the mirror 18. A first image is captured with the camera of a shadow of itself (remote device 58). The accelerometer, the gyroscope, and the compass are used to calculate horizontal directional angle of the sun with respect to the frame 41 using the first image. A second image is captured with the camera of the target 12, 14, in which the accelerometer, the gyroscope, and the compass are used to calculate elevation of the target 12, 14, and the horizontal directional angle of the target 12, 14 with respect to frame 41. The computing system 56 wirelessly receives the location of the frame 41 and the approximate alignment of the frame 41 relative to the target 12, 14 from the remote device 58.

In certain embodiments, the first actuator 51 includes a first gear 36, a first gear arm 30 disposed along the vertical axis and fixedly coupled to the first gear 36, and a first motor 43 driving the first gear 36. The first actuator 51 may further include a first gear box 32 housing a first drive shaft 34 coupled to a first spur gear 35 and a first worm gear shaft 54 with a first worm gear 52 interlocked with the first spur gear 35 and the first gear 36. The first motor 43 drives the first drive shaft 34 which rotates the first spur gear 35, which rotates the first worm gear 52, which rotates the first gear 36, turning the mirror 18 about the vertical axis. The second actuator 53 includes a second gear 24, a second gear arm 28 disposed along the horizontal axis and fixedly coupled to the second gear 24 and the mirror 18 by a bracket 26. A second motor 45 drives the second gear 24. The second actuator 53 may further include a second gear box 44 housing a second drive shaft 46 coupled to a second spur gear 37 and a second worm gear shaft 50 with a second worm gear 48 interlocked with the second spur gear 37 and the second gear 24. The second motor 45 drives the second shaft 46 which rotates the second spur gear 37, which rotates the second worm gear 48, which rotates the second gear 24, turning the mirror 18 about the horizontal axis. The computing system 56 sends a first signal 70 to the first motor 43 and a second signal 68 to the second motor 45 when the angle of the mirror is to be adjusted 18.

The gearboxes 32, 44 are self-locking, and thereby prevent the mirror 18 from moving unless the gears 24, 36 are driven. The second actuator 53 interfaces between the mirror 18 and the first actuator 51. The second actuator 53 tilts the mirror 18 upward and downward. The first actuator 51 interfaces between the second actuator 53 and the chassis 40. The first actuator 51 spins both the second actuator 53 and the mirror 18 from side to side. The self-locking mechanism in the self-locking gearboxes 32, 44 uses the self-locking property of the worm gears 48, 52. The worm gears 48, 52 and spur gears 35, 37 in the gearboxes 32, 44 reduces the speed of the motors 43, 45. The motors 43, 45 engage the spur gears 35, 37, which in turn engages the worm gears 48, 52. The heliostat frame 41 refers to a vector frame defined by the Azimuth at angle 0 and Zenith at angle 0.

In certain embodiments, the present invention uses a solar panel 20. The solar panel 20 may be coupled to the mirror 18. The solar panel 20 is electrically connected to a battery and the battery powers the computing system 56 and the first and second actuators 51, 53.

The angle indicator 22, 38 may include a first disc 38 disposed along the first gear 36. The first disc 38 includes an outer edge having a plurality of markers indicating a fixed incremental angle change along the vertical axis. A first optical sensor 72 sends signals 64 to the computing system 56 to indicate a change in angle of the mirror 18 relative to the frame 41 along the vertical axis. A second disc 22 disposed along the second gear 24 and includes an outer edge having a plurality of markers indicating a fixed increment angle change along the horizontal axis. A second optical sensor 74 sends signals 60 to the computing system 56 to indicate a change in angle of the mirror 18 relative to the frame 41 along the horizontal axis. The outer edge of the first disc 38 and the second disc 22 may each further include a plurality of angle code patterns indicating an angle of the mirror 18 relative to the frame 41 along the vertical axis and the horizontal axis. The optical sensors 72, 74 read the plurality angle code patterns of the first disc 38 and the second disc 22. The first optical sensor 72 sends signals 66 to the computing system 56 to indicate an angle of the mirror 18 relative to the frame 40 along the vertical axis. A second optical sensor 74 sends signals 62 to the computing system 56 to indicate an angle of the mirror 18 relative to the frame 40 along the horizontal axis.

The computing system 56 steps the motors 43, 45 in fixed incremental steps using the angle coding system described above. In this way, the computing system 56 keeps track of the angle incremented for each of the motors 43, 45. The computing system 56 is also able to verify the angle correctness of each axis of the mirror 18 whenever an axis movement makes sufficiently differentiable code pattern change in the angle coding system for that axis. If angle verification fails for some reason, further movement of the angle coding system eventually produces a uniquely identifiable angle code pattern to allow the computing system 56 to establish a valid angle code. For the axis that has angle limits, the angle coding system prevents the computing system 56 from driving the actuators 51, 53 beyond that.

The user interface of the remote device 58 provides GUI to the user. Using the steps mentioned above, the computing system 56 calculates the exact location and approximate alignment of the mirror 18, the elevation of the target 12, 14, and the relative horizontal directional angle between the mirror direction, the sun direction, and the target direction. The calculated result is then sent over the wireless communications channel to program the computing system 56. The computing system 56 derives the approximate alignment of the heliostat frame 41 from the approximate alignment of the mirror 18. The computing system 56 calculates the sun position using the time from the time keeper. Using the sun position, the exact location and approximated alignment of the heliostat frame 41, and the approximated alignment of the intended target 12, 14, the computing system 56 calculates the approximate mirror angles. The computing system 56 then steps the motors 43, 45 to their respective calculated angles.

Since the heliostat frame alignment is approximated, the reflected sunlight 16 may not hit the intended target. The user through the user interface and over the wireless communication, can command the computing system 56 to step the motors 43, 45 to nudge the reflected sunlight 16 into the intended target 12, 14. Once that happens, the position of the sun and the mirror 18 angles establishes the exact condition whereby the sunlight 16 reflects exactly on target. Over time, the sunlight 16 may drift away since the heliostat frame 41 alignment is approximated. Using the same process as before, the user can again nudge the reflected sunlight 16 into the intended target 12, 14. There are now two exact conditions whereby the sunlight 16 reflects exactly on target 12, 14. The remote device 58 may use these two conditions to refine the heliostat frame alignment approximation. The refined alignment approximation is then sent over the wireless channel to program into the computing system 56. By iterating this process, more and more exact conditions further refine the heliostat frame 41 alignment approximation. With the exact location and with refinement of heliostat frame 41 alignment approximation refined over time with sun at different positions in the sky, the computing system 56 alone keeps calculating the angle of the sun periodically using the time keeper, keeping the sunlight 16 on intended target 12, 14.

The user interface may allow the user to add more targets besides the first target 12, 14 using the above mentioned steps. The user interface may further allow targets 12, 14 to be scheduled and manipulated in various ways. For example, the user may direct the heliostat 10 to sweep reflected sunlight 16 from one target to another, and another. The user interface may further allow more than one heliostats 10 to be operated.

The heliostat 10 could be placed anywhere in the line of sight outside the window 14, skylight, or any opening through which the person would like to have sunlight 16 reflected by the heliostat 10 into the house 12. If it is not possible to place the heliostat 10 in the line of sight, a reflective surface may be placed in its stead, and the heliostat 10 placed in a way such that reflection from it could be bounced off the reflective surface and through window 14. The heliostat 10 could be place at any distance from the window 14 depending on the size of the window 14.

The present invention could be used with any device that needs to track the sun, such as a photo-voltaic array or some other solar products. The present invention could be used in photography, movie making, or some artistic uses that benefit from natural light. The present invention could be used for Solar cooking, baking bricks, scaled down power generation, or uses that benefit from concentration of heat. The present invention could be used for indoor planting, green house, or some other indoor farming that could benefit from natural light.

Any of the non-precision manufactured elements throughout the present invention could be replaced with a precision element either with precision manufacturing or manufacturing screening. Adding a communications repeater separate from the main unit can increase the distance of the communications channel, which then allows the user to be further away from the heliostat 10. A component may be added to the smartphone to let the user take a picture with the camera of the horizon. The smartphone can then calculate the entire annual range of the sun and present it to the user through the user interface. The user can then decide from the picture if the place the user stood is a good heliostat installation spot. One or more components in smart phone like gyroscope and compass, accelerometer, and GPS, could be shuffled into the heliostat 10 to link directly with the computing system 56. The worm gears and spur gears chain sequence can be interchanged or reconfigured. The self-locking worm gear could be place anywhere in the chain of speed reducing spur gears. The gear ratios could be re-configured.

It should be understood, of course, that the foregoing relates to exemplary embodiments of the invention and that modifications may be made without departing from the spirit and scope of the invention as set forth in the following claims.

What is claimed is:

1. A heliostat system comprising:
a frame;
a mirror coupled to the frame;
a first actuator configured to rotate the mirror about a horizontal axis relative to the frame;
a second actuator configured to rotate the mirror about a vertical axis relative to the frame;
an angle indicator comprising data indicating an angle of the mirror relative to the frame;
a time keeper; and
a computing system comprising a processor, a memory, and a wireless communications interface, wherein the processor
calculates a sun position using the time keeper,
determines an approximate mirror angle to reflect sunlight towards a target by utilizing the sun position, a location of the frame, and an approximate alignment of the frame relative the target,
automatically adjusts the mirror to the approximate mirror angle based on the angle indicator by activating the first and second actuators, and
manually adjusts the mirror from the approximate mirror angle to an angle that reflects the sunlight to the target by wirelessly receiving a manual input from a remote device via the wireless communications interface if the mirror is not reflecting the sunlight to the target at the approximate mirror angle, wherein
subsequent approximate mirror angles are refined based on the manual input.

2. The heliostat system of claim 1, further comprising the remote device, wherein the remote device is a smart phone.

3. The heliostat system of claim 2, wherein the smart phone comprises:
a processor;
a memory;
a wireless communication interface;
a global positioning system;
an accelerometer;
a gyroscope;
a compass; and
a camera.

4. The heliostat system of claim 3, wherein the location of the frame is determined by placing the smart phone on the mirror, wherein the global positioning system records the location.

5. The heliostat system of claim 4, the approximate alignment of the frame relative to the target is determined by placing the smart phone on the mirror, wherein the accelerometer measures a 2-axis inclination of the mirror, capturing a first image with the camera of a shadow of itself, wherein the accelerometer, the gyroscope, and the compass are used to calculate horizontal directional angle of the sun with respect to the frame using the first image, and capturing a second image with the camera of the target, wherein the accelerometer, the gyroscope, and the compass are used to calculate elevation of the target, and the horizontal directional angle of the target with respect to frame.

6. The heliostat system of claim 5, wherein the computing system wirelessly receives the location of the frame and the approximate alignment of the frame relative to the target from the remote device.

7. The heliostat of claim 1, further comprising a solar panel coupled to the mirror and electrically connected to a battery, wherein the battery powers the computing system and the first and second actuators.

8. The heliostat of claim 1, wherein the first actuator comprises:
a first gear;
a first gear arm disposed along the vertical axis and fixedly coupled to the first gear; and
a first motor driving the first gear.

9. The heliostat of claim 8, wherein the first actuator further comprises:
a first spur gear; and
a first worm gear, wherein
the first motor drives the first spur gear, the first spur gear is interlocked with the first worm gear, and the first worm gear is interlocked with the first gear.

10. The heliostat of claim 8, wherein the second actuator comprises:
a second gear coupled to the mirror;
a second gear arm disposed along the horizontal axis and fixedly coupled to the second gear; and
a second motor driving the upper gear.

11. The heliostat of claim 10, wherein the second actuator further comprises:
a second spur gear; and
a second worm gear, wherein
the second motor drives the second spur gear, the second spur gear is interlocked with the second worm gear, and the second worm gear is interlocked with the second gear.

12. The heliostat of claim 11, wherein the computing system further comprises an optical sensor configured to read the angle indicator.

13. The heliostat of claim 12, wherein the angle indicator comprises:
a first disc disposed along the first gear and comprising an outer edge comprising a plurality of markers indicating a fixed incremental angle change along the vertical axis; and
a second disc disposed along the second gear and comprising an outer edge comprising a plurality of markers indicating a fixed increment angle change along the horizontal axis, wherein
the optical sensor reads the plurality markers of the first disc and the second disc.

14. The heliostat of claim 13, wherein the outer edge of the first disc further comprises a plurality of angle code patterns indicating an angle of the mirror relative to the frame along the vertical axis, and the outer edge of the second disc further comprises a plurality of angle code patterns indicating an angle of the mirror relative to the frame along the horizontal axis, wherein the optical sensor reads the plurality angle code patterns of the first disc and the second disc.
